(19) United States
(12) Patent Application Publication
(10) Pub. No.: US 2013/0307427 A1
(43) Pub. Date: Nov. 21, 2013

(54) CURRENT BALANCING LED DRIVER CIRCUIT AND METHOD THEROF

(71) Applicant: National Cheng Kung University, Tainan City (TW)

(72) Inventors: Tsorng-Juu Liang, Tainan City (TW); Tzu-Hsuan Kuo, Tainan City (TW); Wei-Ching Tseng, Tainan City (TW); Jiann-Fuh Chen, Tainan City (TW)

(73) Assignee: National Cheng Kung University, Tainan City (TW)

(21) Appl. No.: 13/895,768

(22) Filed: May 16, 2013

(30) Foreign Application Priority Data
May 16, 2012 (TW) 101117480

(51) Int. Cl. H05B 37/02

(52) U.S. Cl. CPC H05B 37/02
USPC 315/201; 315/205; 363/67

(57) ABSTRACT

A light emitting diode current-balancing driving circuit is provided. In accordance with the first aspect of the present invention, a light emitting diode current-balancing driving circuit is provided. The light emitting diode current-balancing driving circuit includes a plurality of rectifiers; a current-balancing circuit having a plurality of capacitors respectively coupled to the plurality of rectifiers; and a plurality of diodes electrically connected to the plurality of rectifiers respectively.

### CROSS-REFERENCES TO RELATED APPLICATIONS

The application claims the benefits of Taiwan Patent Application Number 101117480 filed on May 16, 2012, in the Taiwan Intellectual Property Office, the disclosures of which are incorporated herein in their entirety by reference.

### FIELD OF THE INVENTION

The present invention relates to a current-balancing LED driving circuit, in particular to a current-balancing LED driving circuit with a current-balancing control circuit.

### BACKGROUND OF THE INVENTION

Light-emitting diodes in relatively higher power applications are often driving in a multi-serial manner, but the current-balancing of the driving problem needs to be overcome.

The domestic and international LED driving circuit technology in relatively higher power applications is a DC driving LED, whereby the current-balancing mechanism is less easy to design. In addition, some prior art is a pulse driving, but the driving signal thereof has only a half cycle and this will also affect the LED usage and light output.

A thought-provoking question is how to meet the commonly used power converter of the front stage with single/double, isolated/non-isolated AC output in order to design the current-balancing mechanism, thereby enhancing its usage and light output.

Therefore, the present invention provides a current-balancing LED driving circuit and method thereof in order to achieve the foresaid objective.

### SUMMARY OF THE INVENTION

In accordance with the first aspect of the present invention, a light emitting diode current-balancing driving circuit is provided. The light emitting diode current-balancing driving circuit includes a plurality of rectifiers; a current-balancing circuit having a plurality of capacitors respectively coupled to the plurality of rectifiers; and a plurality of diodes electrically connected to the plurality of rectifiers respectively.

In accordance with the second aspect of the present invention, a driving circuit is provided. The driving circuit includes a resonant tank having an inductor; a current-balancing circuit having a plurality of capacitors coupled with the inductor; and a plurality of rectifiers electrically connected to the current-balancing circuit.

In accordance with the third aspect of the present invention, a method for driving a current-balancing circuit is provided. The method for driving a current-balancing circuit includes steps of providing a plurality of serially connected circuits respectively having a plurality of capacitors respectively having a plurality of capacitive reactances; and causing the plurality of serially connected circuits respectively having a plurality of reactances to be respectively determined by the capacitive reactances.

### BRIEF DESCRIPTION OF THE DRAWINGS

Other objects, advantages and efficacy of the present invention will be described in detail below taken from the preferred embodiments with reference to the accompanying drawings, in which:

FIG. 1 is a circuit diagram illustrating a current-balancing LED driving circuit according to the first embodiment of the present invention.

FIG. 2 is a block diagram illustrating a current-balancing LED driving circuit according to the second embodiment of the present invention.

FIG. 3 is a block diagram illustrating a current-balancing LED driving circuit according to the third embodiment of the present invention.

FIG. 4 is a circuit diagram illustrating a current-balancing LED driving circuit according to the fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

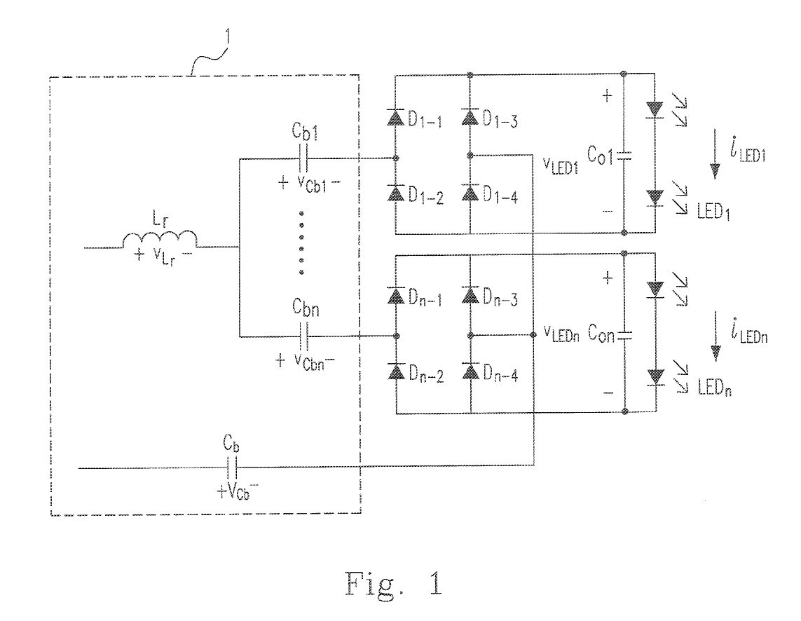

FIG. 1 shows a high frequency pulse LED current-balancing mechanism. The driving output uses the alternating current signals (square wave, sine wave or triangle wave), which is bridge-rectified, generated by the designed resonant tank to driving the LED, and has a current-balancing circuit for driving strings of LED. The core of the current-balancing mechanism is combining the resonant capacitors of the resonant circuit, wherein the resonant capacitors are also the current-balancing capacitors. By using a series-parallel connection, the capacitive reactance dominates the impedance of every string of the LED to achieve the current-balancing for every string of the LED. A filter capacitor (Cₒ₁ . . . Cₒₙ) is configured in parallel with a load end in some cases, i.e. there are two options “to-be-added” and “not-to-be-added” for each of the capacitor (Cₒ₁ . . . Cₒₙ). FIG. 1 is a circuit diagram of the LED current-balancing driving circuit according to the first preferred embodiment.

In FIG. 1, the LED current-balancing driving circuit includes a resonant tank converter which includes a resonant tank (a resonant tank converter and a current-balancing strategy core 1), a inductance Lᵣ (having a voltage stress V_{Lr}), a plurality of capacitors coupled to the inductance (C_{b1} . . . C_{bn}, each having a voltage stress v_{Cb1} . . . v_{Cbn}), a plurality of bridge-rectifiers (each having 4 rectifying LED: D₁₋₁, D₁₋₂, D₁₋₃, D₁₋₄; Dₙ₋₁ , Dₙ₋₂, Dₙ₋₃, Dₙ₋₄), a current-balancing control circuit including the plurality of capacitors (C_{b1} . . . C_{bn}) which are in series with the plurality of bridge-rectifiers respectively, and a LED module, having a plurality of strings of LED (LED₁ . . . LEDₙ), electrically coupled to the plurality of bridge-rectifiers respectively. An additional capacitor C_{b} can be in series between the nth rectifier and a ground. The connection of the positive end and negative end of the capacitor C_{b} is the same as the other capacitors C_{b1} . . . C_{bn} thereof.

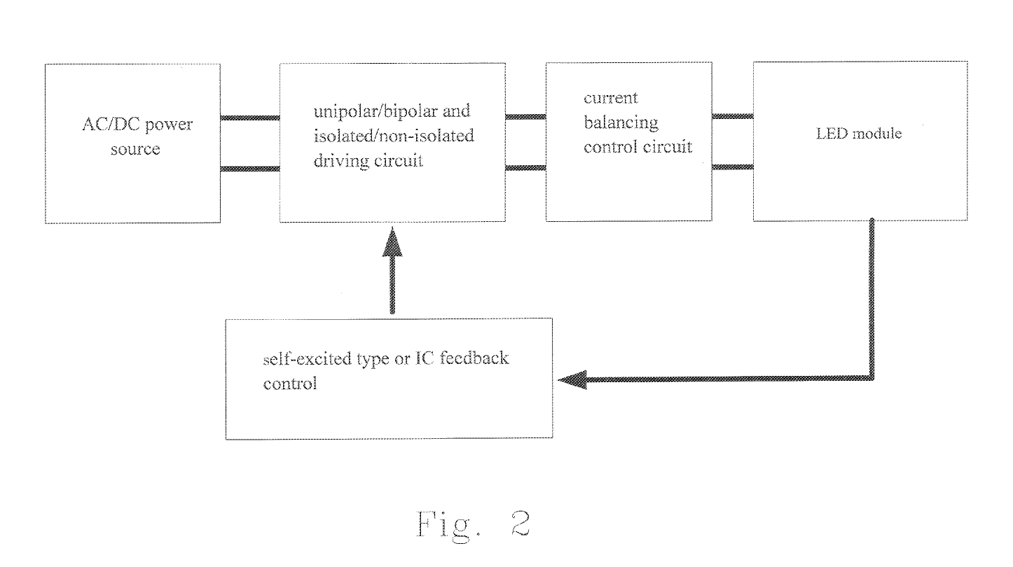

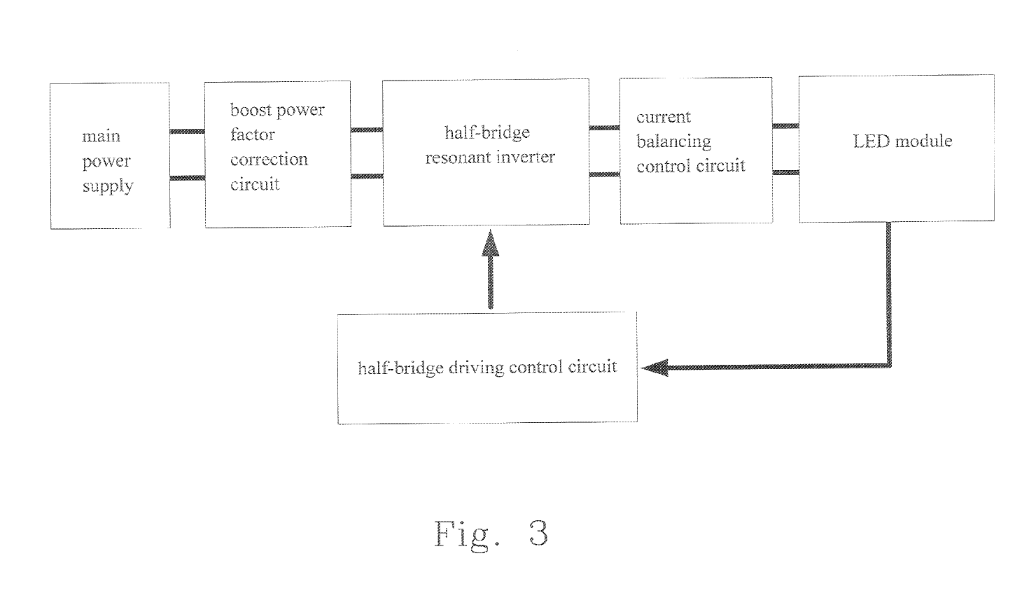

FIG. 2 is a block diagram of the LED current-balancing driving circuit according to the second preferred embodiment. The circuit includes an AC/DC power source, a unipolar/bipolar and isolated/non-isolated driving circuit, a current-balancing circuit, and a LED module having strings of LED. There are wide applications for the present technology. It can be connected to any form of AC output unipolar/bipolar and isolated/non-isolated power converters. Its driving controlling method can also be selected from either a self-excited type or a IC feedback control, as shown in FIG. 2. Furthermore, a coupling adaptor can be added into the current-balancing mechanism for cooperating with the current-balancing capacitor according to the user's preference, in order to enhance the current-balancing effect, as shown in FIG. 3.

FIG. 3 shows the third preferred embodiment of the present invention, the block diagram of the LED current-balancing circuit. This current-balancing circuit is suitable for any AC driving multiple strings of LED converters. FIG. 3 shows a circuit implementation architecture. The circuit includes a pair of level high-frequency pulse LED current-balancing driving circuit. The circuit architecture consists of a main power supply, a boost power factor correction circuit, a half-bridge resonant inverter controlled by the half-bridge driving control circuit, a current-balancing control circuit and the current-balancing strategy is applied to driving a set of multiple strings of light-emitting diode modules. The inductor current of the boost power factor correction circuit operates in the boundary conduction mode to obtain high power factors; The half-bridge resonant converter outputs a high-frequency sine wave which is rectified by the bridge to driving the LED module and adjust the current of the LED via frequency conversion; The resonant capacitor of the half-bridge resonant converter is the core of the current-balancing strategy, it is connected to the strings of LED in series to dominate the impedance of the LED to achieve the current-balancing effect.

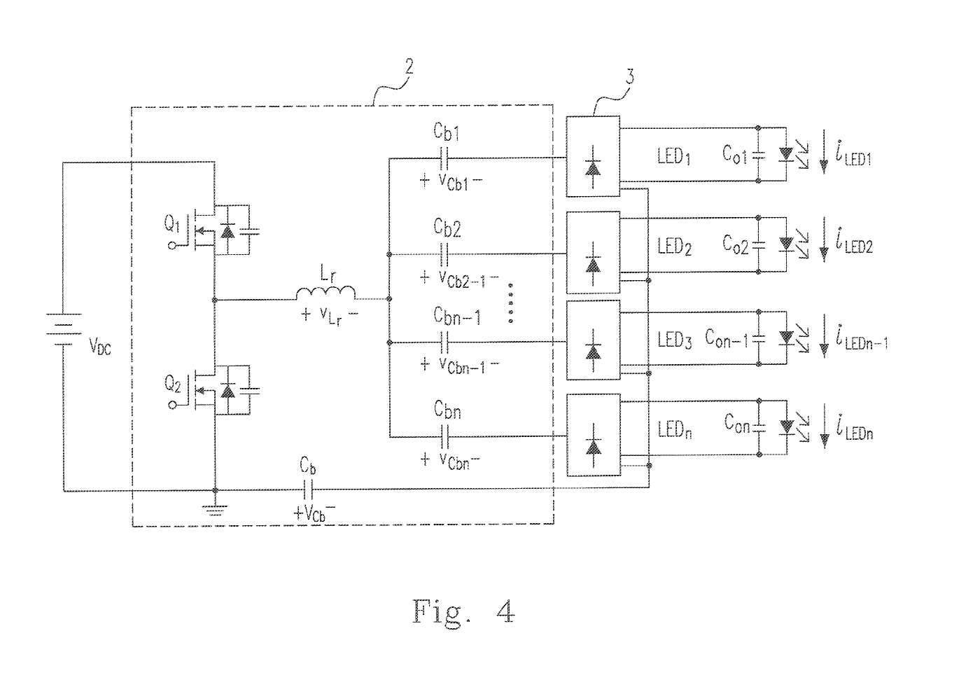

FIG. 4 is a circuit diagram of a current-balancing driving circuit of an LED according to the fourth preferred embodiment of the present invention. Subject to the situation, this connects the filter capacitor (Cₒ₁ . . . Cₒₙ) in parallel to the load, that is, the capacitor (Cₒ₁ . . . Cₒₙ), having two options as “to be added” or “not to be added”. In FIG. 4, the LED current-balancing driving circuit includes a DC power source V_{DC}, a set of half-bridge switches (Q₁+Q₂) is electrically connected to the DC power pack V_{DC} and generates a square wave. A resonant tank electrically connected to the set of half-bridge switches, and possessed an inductor Lᵣ (with a crossing voltage V_{Lr}) and that is coupled with a plurality of capacitors (C_{b1} . . . C_{bn}, each with a crossing voltage v_{Cb1} . . . v_{Cbn}; a resonant tank inverter and the current-balancing strategic core 2, which includes: the set of half-bridge switches, the inductor with the plurality of capacitors), a plurality of bridge rectifiers (3s), a current-balancing control circuit including a plurality of capacitors (Cₒ₁ . . . Cₒₙ), connected in series with the plurality of bridge rectifiers (3s) respectively, and a LED module with a plurality of strings of light-emitting diode (LED₁ . . . LEDₙ) are electrically connected to the plurality of bridge rectifier (3s). Of course, the nth rectifier and a ground can be connected in series with an extra capacitance C_{b}. The connection of the capacitor C_{b} is the same as the other capacitor C_{b1} . . . C_{bn}.

There are further embodiments provided as follows:

Embodiment 1: A light emitting diode current-balancing driving circuit includes a plurality of rectifiers; a current-balancing circuit having a plurality of capacitors respectively coupled to the plurality of rectifiers; and a plurality of diodes electrically connected to the plurality of rectifiers respectively.

Embodiment 2: A light emitting diode current-balancing driving circuit according to Embodiment 1, the capacitors are resonant capacitors.

Embodiment 3: A light emitting current-balancing diode driving circuit according to Embodiment 1 further includes a converter electrically connected to the current-balancing circuit and generating an alternating current.

Embodiment 4: A light emitting current-balancing diode driving circuit according to Embodiment 3, the converter is electrically connected to the plurality of capacitors.

Embodiment 5: A light emitting diode current-balancing driving circuit according to Embodiment 4, the plurality of rectifiers are a plurality of diode rectifiers being ones of general diodes and light emitting diodes.

Embodiment 6: A light emitting diode current-balancing driving circuit according to Embodiment 4, the converter is one of single stage and two stage converters.

Embodiment 7: A light emitting diode current-balancing driving circuit according to Embodiment 4, the converter is one of isolated and non-isolated converters.

Embodiment 8: A light emitting diode current-balancing driving circuit according to Embodiment 4, the current-balancing circuit has a plurality of coupled transformers respectively connected between the plurality of resonant capacitors and the plurality of rectifiers.

Embodiment 9: A light emitting diode current-balancing driving circuit according to Embodiment 3, the alternating current has one selected from the group consisting of a square wave, a sine wave, a triangular wave and a combination thereof.

Embodiment 10: A driving circuit includes a resonant tank having an inductor; a current-balancing circuit having a plurality of capacitors coupled with the inductor; and a plurality of rectifiers electrically connected to the current-balancing circuit.

Embodiment 11: A driving circuit according to Embodiment 10, the capacitors of the current-balancing circuit are resonant capacitors serially connected to the plurality of rectifiers respectively.

Embodiment 12: A driving circuit according to Embodiment 10 further includes a light emitting diode module having a plurality of sets of serially connected diodes, the plurality of sets are respectively connected to the plurality of rectifiers.

Embodiment 13: A driving circuit according to Embodiment 10, the rectifiers are bridge rectifiers.

Embodiment 14: A driving circuit according to Embodiment 10 further includes a DC power supply; and a switch set electrically connected to the DC power supply and the resonant tank for generating a square wave.

Embodiment 15: A driving circuit according to Embodiment 14, the switch set is a half-bridge switch.

Embodiment 16: A driving circuit according to Embodiment 14, the inductor has a first end and a second end, the DC power supply has an anode and a cathode, the switch set has a first and a second switches having a first end and a second end, the anode electrically connects with the first end of the first switch, the cathode electrically connects with the first end of the second switch and ground, the second end of the first switch electrically connects with the first end of the second switch and the first end of the inductor, in which the second end of the inductor electrically connects with the plurality of capacitors.

Embodiment 17: A driving circuit according to Embodiment 16, the switch set is a half-bridge switch.

Embodiment 18: A method for driving a current-balancing circuit includes steps of providing a plurality of serially connected circuits respectively having a plurality of capacitors respectively having a plurality of capacitive reactances; and causing the plurality of serially connected circuits respectively having a plurality of reactances to be respectively determined by the capacitive reactances.

Embodiment 19: A method for driving a current-balancing circuit according to Embodiment 18, each of the plurality of serially connected circuits electrically connects thereof at least one light emitting diode.

Embodiment 20: A method for driving a current-balancing circuit according to Embodiment 18, the capacitors are the resonant capacitors.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A light emitting diode current-balancing driving circuit comprising:
a plurality of rectifiers;
a current-balancing circuit having a plurality of capacitors respectively coupled to the plurality of rectifiers; and
a plurality of diodes electrically connected to the plurality of rectifiers respectively.

2. A light emitting diode current-balancing driving circuit according to claim 1, wherein the capacitors are resonant capacitors.

3. A light emitting current-balancing diode driving circuit according to claim 1, further comprising a converter electrically connected to the current-balancing circuit and generating an alternating current.

4. A light emitting current-balancing diode driving circuit according to claim 3, wherein the converter is electrically connected to the plurality of capacitors.

5. A light emitting diode current-balancing driving circuit according to claim 4, wherein the plurality of rectifiers are a plurality of diode rectifiers being ones of general diodes and light emitting diodes.

6. A light emitting diode current-balancing driving circuit according to claim 4, wherein the converter is one of single stage and two stage converters.

7. A light emitting diode current-balancing driving circuit according to claim 4, wherein the converter is one of isolated and non-isolated converters.

8. A light emitting diode current-balancing driving circuit according to claim 4, wherein the current-balancing circuit has a plurality of coupled transformers respectively connected between the plurality of resonant capacitors and the plurality of rectifiers.

9. A light emitting diode current-balancing driving circuit according to claim 3, wherein the alternating current has one selected from the group consisting of a square wave, a sine wave, a triangular wave and a combination thereof.

10. A driving circuit comprising:
a resonant tank having an inductor;
a current-balancing circuit having a plurality of capacitors coupled with the inductor; and
a plurality of rectifiers electrically connected to the current-balancing circuit.

11. A driving circuit according to claim 10, wherein the capacitors of the current-balancing circuit are resonant capacitors serially connected to the plurality of rectifiers respectively.

12. A driving circuit according to claim 10, further comprising a light emitting diode module having a plurality of sets of serially connected diodes, wherein the plurality of sets are respectively connected to the plurality of rectifiers.

13. A driving circuit according to claim 10, wherein the rectifiers are bridge rectifiers.

14. A driving circuit according to claim 10, further comprising:
a DC power supply; and
a switch set electrically connected to the DC power supply and the resonant tank for generating a square wave.

15. A driving circuit according to claim 14, wherein the switch set is a half-bridge switch.

16. A driving circuit according to claim 14, wherein the inductor has a first end and a second end, the DC power supply has an anode and a cathode, the switch set has a first and a second switches having a first end and a second end, the anode electrically connects with the first end of the first switch, the cathode electrically connects with the first end of the second switch and ground, the second end of the first switch electrically connects with the first end of the second switch and the first end of the inductor, in which the second end of the inductor electrically connects with the plurality of capacitors.

17. A driving circuit according to claim 16, wherein the switch set is a half-bridge switch.

18. A method for driving a current-balancing circuit, comprising steps of:
providing a plurality of serially connected circuits respectively having a plurality of capacitors respectively having a plurality of capacitive reactances; and
causing the plurality of serially connected circuits respectively having a plurality of reactances to be respectively determined by the capacitive reactances.

19. A method for driving a current-balancing circuit according to claim 18, wherein each of the plurality of serially connected circuits electrically connects thereof at least one light emitting diode.

20. A method for driving a current-balancing circuit according to claim 18, wherein the capacitors are the resonant capacitors.
